(19) United States
(12) Patent Application Publication
(10) Pub. No.: US 2009/0123021 A1
(43) Pub. Date: May 14, 2009

(54) System, method, and medium indexing photos semantically

(75) Inventors: Yong Ju Jung, Yongin-si (KR); Jae Won Lee, Yongin-si (KR); Ji Yeun Kim, Yongin-si (KR); Sang Kyun Kim, Yongin-si (KR); Ick Sang Han, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/698,203

(22) Filed: Jan. 26, 2007

(30) Foreign Application Priority Data
Sep. 27, 2006 (KR) 10-2006-0094323

(51) Int. Cl. G06K 9/00; G06F 7/00; G06F 17/00

(52) U.S. Cl. 382/100; 715/230; 707/102

(57) ABSTRACT

A system, method and medium indexing a plurality of photos semantically based on a user's annotation. The method includes analyzing the user's annotation and extracting a shared index from the user's annotation, detecting a situation change in the plurality of photos, and indexing the plurality of photos according to the situation change based on the shared index.

### CROSS-REFERENCE TO RELATED APPLICATIONS

This application claims the benefit of Korean Patent Application No. 10-2006-0094323, filed on Sep. 27, 2006, in the Korean Intellectual Property Office, the disclosure of which is incorporated herein by reference.

### BACKGROUND

1. Field

One or more embodiments of the present invention relate to a system, method, and medium indexing photos semantically, and more particularly, to a system, method, and medium indexing photos semantically, which receives an annotation of at least one photo of a plurality of photos from a user, analyzes the annotation and the plurality of photos, and performs semantic indexing of the photo according to a situation change.

2. Description of the Related Art

Generally, file names of photos taken with a digital camera are consecutively numbered by the camera. Accordingly, little information about a photo is derived from the file name and a user searching for a particular photo is required to review the photos one by one, a very time-consuming process.

Alternatively, in conventional digital cameras, a user is required to type a unique file name for each photo when storing the photos, in order to retrieve the particular photo more easily. Otherwise, a user is required to type the file names, while checking each of the photos respectively, after storing the photos. It is inconvenient for the user to type file names of each photo when many photos need to be stored. Accordingly, a more convenient method of indexing photos taken by a digital camera is needed.

In an example of a photo indexing method in the conventional art, an annotation of an image in a database is deduced as the best annotation for a new image through a similarity matching of content based image retrieval (CBIR).

Also, in the conventional art, a photo group including two or more similar photos is annotated.

Also, in the conventional art, information captured when taking a photo by a camera phone is transmitted to a server, and the closet annotation is deduced through a matching algorithm. However, a specific matching algorithm has not been proposed.

As described above, in conventional techniques of indexing a photo, similar photos are grouped by low level features such as time, place, and image characteristics, and thereby annotated as a group. However, the methods do not satisfy users who require more accurate indexing.

Accordingly, a more accurate method of indexing digital photos is required.

### SUMMARY

An aspect of the present invention provides a system, method, and medium indexing photos semantically, which analyze a user's annotation and an image, and thereby may perform semantic indexing more accurately.

An aspect of the present invention also provides a system, method, and medium indexing photos semantically, which share a user's annotation as an index, analyze a plurality of photos, and perform semantic indexing according to a situation change.

An aspect of the present invention also provides a system, method, and medium indexing photos semantically, which perform semantic indexing with a user's annotation in order to generate an image index by using a deduced automatic annotation and to deduce a relationship between a shared index and a segment.

Additional aspects and/or advantages of the invention will be set forth in part in the description which follows and, in part, will be apparent from the description, or may be learned by practice of the invention.

According to an aspect of the present invention, there is provided a method of indexing a plurality of photos semantically, the method including analyzing the user's annotation and extracting a shared index from the user's annotation, detecting a situation change in the plurality of photos, and indexing the plurality of photos according to the situation change based on the shared index.

According to another aspect of the present invention, there is provided a system for indexing a plurality of photos semantically, the system including a shared index extraction unit to analyze the user's annotation and extract a shared index from the user's annotation, a situation change detection unit to detect a situation change, and an indexing unit to index the plurality of photos according to the situation change based on the shared index.

According to another aspect of the present invention, there is provided at least one medium comprising computer readable code to control at least one processing element to implement a method of indexing a plurality of photos semantically based on a user's annotation, the method including analyzing the user's annotation and extracting a shared index from the user's annotation, detecting a situation change in the plurality of photos, and indexing the plurality of photos according to the situation change based on the shared index.

In the present invention, an annotation refers to a description of a photo through a keyword, a free text, or a voice. A user's annotation is annotated by a user, and mainly in a free text form.

Also, in the present invention, an index may refer to a word representing a photo, and may include a semantic tag or semantic keyword. A shared index may refer to a high level index that includes photos which share an overall situation. An image index may refer to a low level index which represents a corresponding photo. Also, an automatic annotation may be automatically deduced in a keyword form.

### BRIEF DESCRIPTION OF THE DRAWINGS

These and/or other aspects and advantages of the invention will become apparent and more readily appreciated from the following description of embodiments, taken in conjunction with the accompanying drawings of which:

FIG. 1 illustrates a system indexing photos semantically, according to an embodiment of the present invention;

FIG. 2 illustrates a concept of semantic indexing through a semantic annotation analysis and index share, according to an embodiment of the present invention;

FIG. 3 illustrates an example of shared index extraction, according to an embodiment of the present invention;

FIG. 4 illustrates an example of semantic indexing by a hierarchical grouping, according to an embodiment of the present invention;

FIG. 5 illustrates an example of a situation change detection unit, according to an embodiment of the present invention;

FIG. 6 illustrates a method of indexing photos semantically, according to another embodiment of the present invention;

FIG. 7 illustrates an example of a generated file name by an annotation, according to an embodiment of the present invention;

FIG. 8 illustrates an example of semantic indexing by a hierarchical grouping, according to an embodiment of the present invention; and

FIG. 9 illustrates an example of a related word associated with a social event as a criteria of a hierarchical grouping, according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

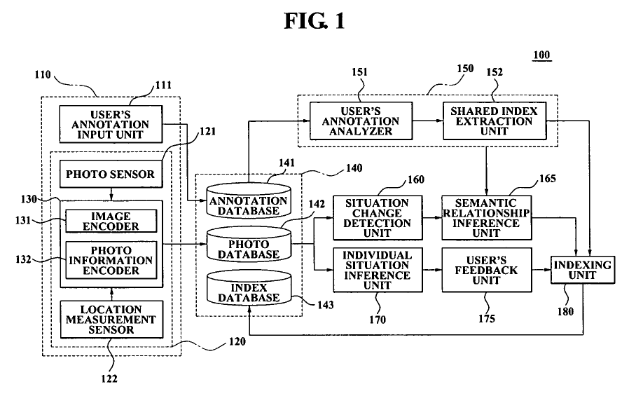

FIG. 1 illustrates a system of indexing photos semantically, according to an embodiment of the present invention.

Referring to FIG. 1, the system of indexing photos semantically 100, according to an embodiment of the present invention may include a receiving unit 110, a database 140, a user's annotation extraction unit 150, a situation change detection unit 160, an individual situation inference unit 170, and an indexing unit 180, for example.

The receiving unit 110 may include a user's annotation input unit 111 and a photo receiving unit 120, for example. The user's annotation input unit 111 may receive an annotation of a photo from a user, and the photo receiving unit 120 may receive a photo from the user. The user's annotation input unit 111 may select any one of the photos which is inputted via the photo receiving unit 120, or a photo which is stored in the database 140. Also, the receiving unit 110 may input an annotation of the selected photo. The annotation may include information associated with the photo, including, as an example, at least one of source time information, source location information, and face information, although other photograph information may also be used. In this instance, the source time information may refer to information about a time when the photo is taken, the source location information may refer to information about a location where the photo is taken, and the face information may refer to information about another face included in the photo with a face, for example.

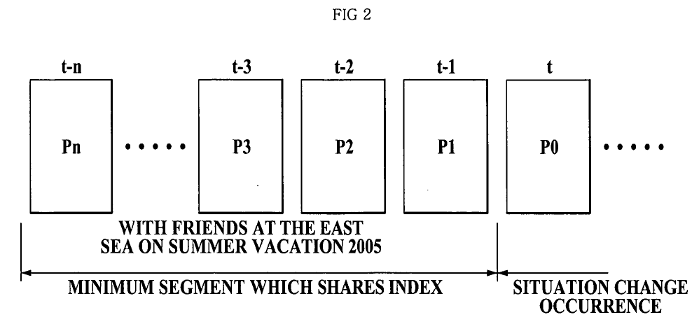

FIG. 2 illustrates a concept of semantic indexing through a semantic annotation analysis and index share, according to an embodiment of the present invention.

Referring to FIG. 2, the user's annotation input unit 111 of FIG. 1 may receive a single photo P₃, selected by a user from photos P₀ through Pₙ as illustrated in FIG. 2, for example. Also, the user's annotation input unit 111 may receive a user's annotation, for example, “with friends at the East Sea on summer vacation 2005” from the user. A first photo P₁ through an n^{th} photo Pₙ are photos taken in an identical location, with identical faces, at an identical time, as the photo annotated by the user. Accordingly, the first photo P₁ through the n^{th} photo Pₙ may share a minimum segment, which shares an index, such as “the East Sea on summer vacation”. A 0^{th} photo P₀ may have, for example, a different time, different location, or different person than the first photo P₁ through the n^{th} photo Pₙ. Accordingly, a situation change with respect to the minimum segment occurs, and the 0^{th} photo P₀ may be classified as a different minimum segment.

The photo receiving unit 120 may include a photo sensor 121, a location measurement sensor 122, and a photo encoding unit 130, for example.

The photo sensor 121 may sense an image including a background, an object, or a person, or any other parameter selected by the user. The location measurement sensor 122 may perform sensing operations to measure a source location, when the photo is taken by the photo sensor 121. The location measurement sensor 122 may be embodied as a global positioning system (GPS) receiver, for example. In an embodiment in which the location measurement sensor 122 is a GPS receiver, the GPS information may be received by a GPS satellite, and the source location may be ascertained based on the GPS information, for example.

The photo encoding unit 130 may include an image encoder 131 and a photo information encoder 132, for example. The photo encoding unit 130 may encode photo information and an image of the photo taken by the photo sensor 121. The image encoder 131 encodes the image of the photo, and the photo information encoder 132 encodes the photo information including the source location information and the source time information of the photo, for example. Also, the photo information may include other photo-related information including, but not limited to, luminance, flash use, and a close-up. The photo information encoder 132 may be an exchangeable image file format (EXIF) encoder, and may encode the other photo-related information, when storing the image of the photo in a particular format. As an example, the photo encoding unit 130 may encode the photo as an image file in a joint photographic experts group (JPEG) format.

The database 140 may include an annotation database 141, a photo database 142, and an index database 142, for example. The database 140 may store and maintain a user's annotation, the photo, and the index. Specifically, the annotation database 141 may store and maintain the user's annotation inputted via the user's annotation input unit 111. The photo database 142 may store and maintain the photo encoded by the photo encoding unit 130, and the index database 143 may store and maintain the index generated by the indexing unit 180, for example.

The user's annotation extraction unit 150 may include a user's annotation analyzer 151 and a shared index extraction unit 152, for example. The user's annotation extraction unit 150 may analyze the user's annotation and extract a shared index from the user's annotation as a result of the analyzing. Specifically, the user's annotation analyzer 151 may analyze the user's annotation inputted by the user's annotation input unit 111, and the shared index extraction unit 152 may extract the shared index from the user's annotation as a result of the analyzing.

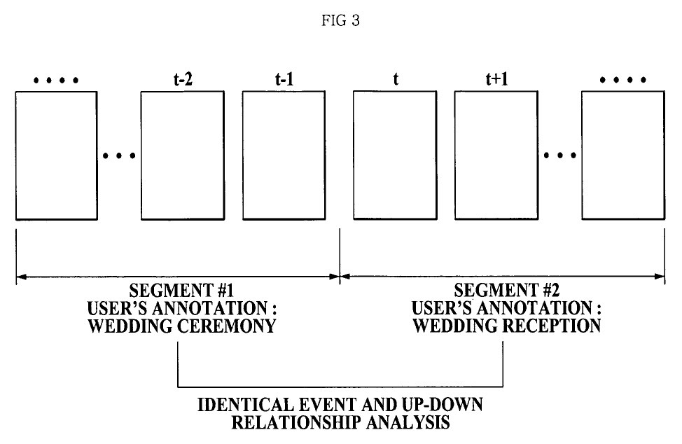

FIG. 3 illustrates an example of shared index extraction, according to an embodiment of the present invention.

Referring to FIG. 3, an example is described in which a word “wedding ceremony”, as the user's annotation, is inputted in a particular photo of photos included in a segment #1, and a word “wedding reception”, as the user's annotation, is inputted in a particular photo of photos included in a segment #2. The user's annotation analyzer 151 may analyze an identical event and up-down relationship through the user's annotation, “wedding ceremony” and “wedding reception”. The shared index extraction unit 152 may extract a shared index, for example, “wedding/wedding ceremony”, which is similar to the “wedding ceremony” and “wedding reception”, as a result of the analyzing. Specifically, the user's annotation extraction unit 150 may analyze the identical event and up-down relationship via the user's annotation analyzer 151, and may extract the shared index based on the result of the analyzing via the shared index extraction unit 152.

The situation change detection unit 160 may analyze a plurality of photos and extract a situation change, for example. Specifically, the situation change detection unit 160 may detect a visual change, a face change, a location change, or a time change of the plurality of photos stored in the photo database 142. Also, the situation change detection unit 160 determines a situation change for the plurality of photos according to one or more of the detected visual change, subject change, location change, and time change.

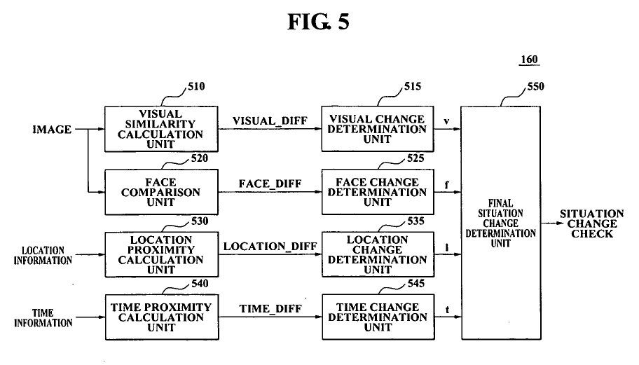

FIG. 5 illustrates an example of a situation change detection unit, according to an embodiment of the present invention.

Referring to FIG. 5, the situation change detection unit 160 may include a visual similarity calculation unit 510, a visual change determination unit 515, a face comparison unit 520, a face change determination unit 525, a location proximity calculation unit 530, a location change determination unit 535, a time proximity calculation unit 540, a time change determination unit 545, and a final situation change determination unit 550, for example.

The visual similarity calculation unit 510 may calculate a visual similarity amongst the plurality of photos stored in the photo database 142. The visual change determination unit 515 may determine the situation change as a visual change, when a visual difference (Visual-Diff) between a standard photo and a comparison photo is equal to, or greater than a predetermined value according to the calculated visual similarity, for example. Specifically, the situation change detection unit 160 may compare a visual image of the standard photo and a visual image of the comparison photo, based on the calculated visual similarity. Also, when the visual difference (Visual-Diff) between the standard photo and the comparison photo is equal to, or greater than the predetermined value, the visual difference may be determined significant, and a situation change may be determined as a visual change (v), for example.

The face comparison unit 520 may compare faces of the plurality of photos. The face change determination unit 525 may determine the situation change as a face change, when a face difference (Face-Diff) between the standard photo and the comparison photo is equal to, or greater than a predetermined value, according to a result of the comparison. In an embodiment, the situation change detection unit 160 may compare a face of the standard photo and a face of the comparison photo. Also, when the visual difference (Visual-Diff) between the standard photo and the comparison photo is equal to, or greater than the predetermined value, the face difference may be determined significant, and a situation change may be determined as a face change (f), for example. Specifically, when the face difference is significant, the situation change detection unit 160 may consider the face of the standard photo and the face of the comparison photo, to be different faces, thereby determining a situation change has occurred. For example, when the face of the standard photo is “AAA” and the face of the comparison photo is “BBB”, the situation change detection unit 160 may determine a situation change as a face change between the face of the standard photo and the face of the comparison photo.

The location proximity calculation unit 530 may compare location information of the standard photo and the comparison photo from the plurality of photos, and may calculate a location proximity between the standard photo and the comparison photo. The location change determination unit 535 may determine a situation change as a location change (l), when a location difference (Location_Diff) between the standard photo and the comparison photo is equal to, or greater than a predetermined value, according to the calculated location proximity. As an example, when a location of the standard photo is “Seoul”, a location of the comparison photo is “Busan”, and the predetermined value of the location difference is “10 km”, the location difference (Location_Diff) between the standard photo and the comparison photo is about 400 km, which is greater than the predetermined valueof 10 km, arbitrarily set by the user. Accordingly, the situation change detection unit 160 may determine a situation change as a location change, for example.

The time proximity calculation unit 540 may calculate a time proximity between the standard photo and the comparison photo, from the plurality of photos, for example. The time change determination unit 545 may determine a situation change as a time change (t), when a time difference (Time_Diff) between the standard photo and the comparison photo is greater than the predetermined value according to the calculated time proximity. As an example, when time information for the standard photo is “July 1^{st}”, time information for the comparison photo is “September 1^{st}”, and the predetermined value is “1 day”, the time difference is “62 days”, which is greater than the arbitrarily user-set predetermined value of “1 day”. Thus, the situation change detection unit 160 may determine a situation change as a time change, for example.

The final situation change determination unit 550 may determine a final situation change based on any one or more of the visual change, the face change, the location change, and the time change. Also, the final situation change determination unit 550 may output a result of the final situation change as a situation change check signal. Specifically, the final situation change determination unit 550 may determine the situation change check through a sum of a weight of the visual change (wᵥ), a weight of the face change (w_{f}), a weight of the location change (wₗ), and a weight of the time change (wₜ), as shown, for example, in Equation 1 below.

score=wᵥv+w_{f}f+wₗl+wₜt, where wᵥ+w_{f}+wₗ+wₜ=1 Equation

A semantic relationship inference unit 165 may deduce a semantic relationship between the plurality of photos based on an analysis result of the user's annotation and the situation change check, for example. Specifically, the semantic relationship inference unit 165 may merge minimum segments having similar content based on the inputted annotation or the analysis result of the situation change check, and may hierarchically group the minimum segments by using an ontology. The semantic relationship inference unit 165 may analyze a semantic relationship between words used in the user's annotation through a knowledge-based analysis using a semantic network, and may merge the minimum segments when a similar segment is included in an identical event or is in an up-down (i.e. genus/species) relationship, for example, the “wedding ceremony” and “wedding reception”. In an embodiment, a condition of the grouping and the merging may be that the plurality of photos is included in a sequential chronological order.

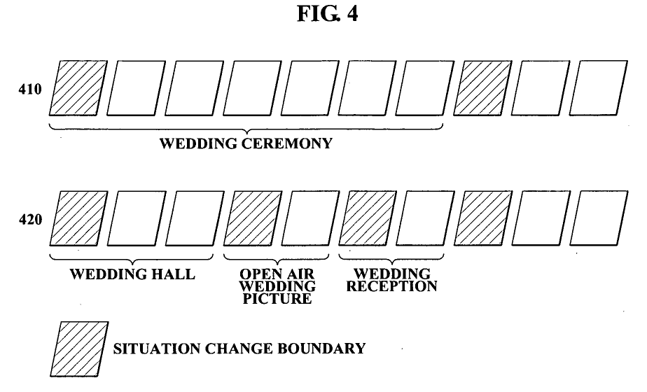

FIG. 4 illustrates an example of semantic indexing by a hierarchical grouping, according to an embodiment of the present invention.

Referring to FIG. 4, as an example, grouped photos associated with “wedding ceremony” 410, and grouped photos associated with “wedding hall”, “open air wedding picture” and “wedding reception” 420, exist. In an embodiment, the “wedding hall”, “open air wedding picture” and “wedding reception” are included in a low level index. The low level index may classify the grouped photos associated with “wedding ceremony”, a high level index, in more detail. As described above, in one or more embodiments of the present invention, when performing semantic indexing, grouped photos classified by a high level index and grouped photos classified by one or more lower level indices may exist. As another example, when the high level index is “Yosemite National Park”, a low level index such as “Vernal Falls” and “Yosemite Falls”, each of which are located in the “Yosemite National Park”, may be available. As another example, when the high level index is “graduation ceremony”, a low level index such as “schoolmate” and “teacher” may be available.

The individual situation inference unit 170 may analyze the plurality of photos stored in the photo database 142 and may deduce any one or more of a date and time (when), a location (where), a person (who), an event (what occasion), an object (with which thing), a behavior or pose (which action), and a category (which category). Also, in an embodiment, in order to prevent a repeated extraction with respect to a portion of the photos which is not changed compared to a previous photo when analyzing the plurality of photos, the individual situation inference unit 170 may deduce the date and time, the location, the person, the event, the object, a behavior or a pose, and the category with respect to only a changed portion, after the situation change detection unit 160 determines an unchanged portion, for example. As an example, when an individual situation is a date and time, the individual situation inference unit 170 may analyze the date and time information as photo information included in the plurality of photos, and may automatically deduce a user's annotation associated with a source time of the plurality of photos. The source time may refer to a time when the photo is taken, for example. As another example, when the individual situation is a location, the individual situation inference unit 170 may analyze location information, for example, GPS information, as the photo information included in the plurality of photos, and may automatically deduce the user's annotation associated with a source location of the plurality of photos. The source location may refer to a location where the photo is taken.

As another example, when the individual situation is a face, the individual situation inference unit 170 may analyze images of the plurality of photos, detect faces of previously registered persons, and may automatically deduce the user's annotation associated with the detected face. The photo database 142 may store and maintain face information of any photographed person for indexing in the plurality of photos. As another example, when the individual situation is an object, the individual situation inference unit 170 may recognize objects of the plurality of photos, and may deduce the user's annotation associated with the recognized object, automatically or limitedly. As another example, when the individual situation is an event, or a behavior or a pose, the individual situation inference unit 170 may deduce what occasion, or which action by using the user's annotation included in the plurality of photos. As another example, when the individual situation is a category, the individual situation inference unit 170 may analyze the image of the plurality of photos, and automatically deduce the category. When automatically deducing the category and only a single category is selected, an error may occur. Accordingly, a soft annotation method may be utilized. For example, the individual situation inference unit 170 may provide a respective proportion such as a building as 0.7%, a background scene as 0.2%, and a water's edge as 0.1%, for example, and may deduce the category which has the greatest proportion. Also, the individual situation inference unit 170 may consider the user's annotation with higher priority, when automatically deducing the category.

The user's feedback unit 175 may feedback the deduced individual situation to the user in order to confirm whether the deduced individual situation is suitable. In an embodiment, the user's feedback unit 175 may confirm, with the user, whether the deduced individual situation and the photo are suitable, after feeding back the deduced individual situation to the user. Accordingly, the system of indexing photos semantically 100 may include the user's feedback unit 175, to obtain feedback from the user, and thereby improve the accuracy of the deducing.

The indexing unit 180 may index the image of the plurality of photos based on the user's annotation as detected by the user's annotation detection unit 150, the semantic relationship deduced by the semantic relationship inference unit 165, and the individual situation deduced by the individual situation inference unit 170, for example. Also, the indexing unit 180 may store a relationship between the index and the plurality of photos in the index database 143, as a result of the indexing. Also, the indexing unit 180 may generate a file name for each photo with respect to photos where the user's annotation is not inputted by the user. The indexing unit 180 may generate the file name as, for example, “when_where_who_event_serial number.JPG”, since photos are generally arranged in chronological order. Specifically, the indexing unit 180 may first provide the source time information, then the source location information, and lastly the face information in the photo, as an example. Also, the indexing unit 180 may add additional context information that is extracted from the photo, such as the event which has occurred in the photo, and thereby may automatically generate the file name of the photo. Although a particular order is described above, the order may be changed according to the preference of the user. As an example, when the user primarily takes portrait photos, the face information of the portrait subject is most important. Accordingly, the face information may be provided first in the file name of the photo. As another example, when the user primarily considers source location information to be important, the source location information may be provided first in the file name of the photo.

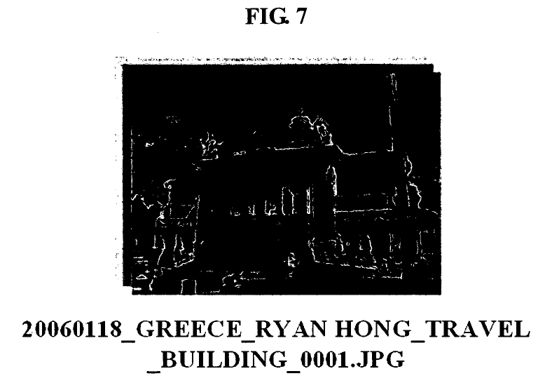

FIG. 7 illustrates an example of generating a file name using an annotation according to an embodiment of the present invention.

As illustrated in FIG. 7, as an example, when the user's annotation is “Ryan Hong, travel” through the user's annotation detection unit 150, the source time information is “Jan. 18^{th}, 2006,” as extracted or detected by the situation change detection unit 160 or the individual situation inference unit 170, the source location information is “Greece”, and object information of the photo is “building”, the indexing unit 180 may generate the file name of the photo as “20060118_Greece_Ryan Hong_Travel_Building_{—}0001 .JPG”.

As described above, the system of indexing photos semantically 100 according to an embodiment of the present invention analyzes the plurality of photos and automatically provides a meaningful annotation for each photo, although the user inputs the annotation for only a few photos. Accordingly, the system indexing photos semantically 100 stores the result of the indexing, and thus the user may retrieve stored photos more conveniently. Also, the system indexing photos semantically 100, according to an embodiment of the present invention generates the file names of the photos by analyzing the user's annotation associated with the photo, as well as the source time information and the source location information, and thereby may provide specific information regarding the photos.

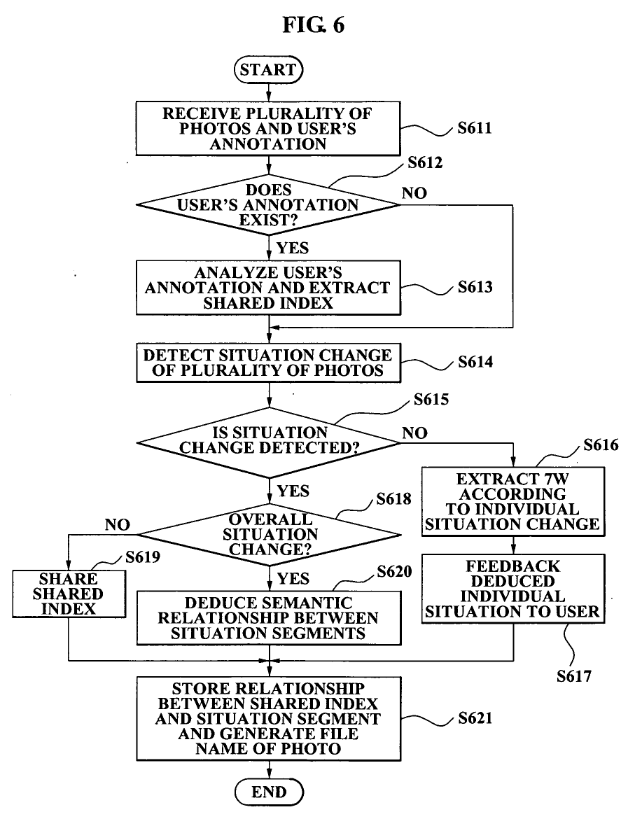

FIG. 6 illustrates a method indexing photos semantically according to another embodiment of the present invention.

Referring to FIG. 6, in operation S611, a system, for example, the system indexing photos semantically 100 of FIG. 1 although other systems may be used, receives a plurality of photos and a user's annotation. The photos may include source time information and source location information, for example. Specifically, in operation S611, the system receives the plurality of photos and receives the user's annotation of at least one photo of the plurality of photos from the user. Also, for example, when one hundred photos are taken during a summer vacation, the system may receive an annotation of a representative photo, such as “with friends at the East Sea on summer vacation 2005” as illustrated in FIG. 2.

In operation S612, the system may analyze the plurality of photos, and may determine whether the user's annotation, corresponding to the analyzed photo, exists. Specifically, the user's annotation may be inputted for only the at least one photo in operation S611, and thus the system may retrieve only a few photos where the user's annotation is inputted.

In operation S613, the system may analyze the user's annotation and extract a shared index.

In operation S614, the system may analyze the plurality of photos, and may detect a situation change in the plurality of photos. Specifically, the system may detect one or more of a visual change, a face change, a location change, and a time change of the plurality of photos, for example.

As an example of a situation change, when a visual change is detected, the system may calculate a visual similarity of the plurality of photos in operation S614. Also, in operation S614, the system may detect the situation change as a visual change between a standard photo and a comparison photo, when a visual difference between the standard photo and the comparison photo is equal to, or greater than a predetermined value according to the calculated visual similarity. For example, when the standard photo is an indoor photo and the comparison photo is an outdoor photo, the system may detect the visual change between the standard photo and the comparison photo, since the visual difference is greater than the predetermined value.

As another example, when the face change is detected, the system of semantic indexing a photo 100 may compare faces in the plurality of photos in operation S614. Also, in operation S614, the system may determine the situation change as a face change, when a face difference between the standard photo and the comparison photo is equal to, or greater than the predetermined value according to a result of the comparison. For example, when the face of the standard photo is “AAA” and the face of the comparison photo is “BBB”, the system may determine the situation change as a face change, when the system compares the face of the standard photo and the face of the comparison photo.

As another example, when a location change is detected, the system may compare location information of the standard photo and the comparison photo from the plurality of photos, and may calculate a location proximity between the standard photo and the comparison photo in operation S614. The system may determine the situation change as a location change, when a location difference between the standard photo and the comparison photo is equal to, or greater than the predetermined value according to the calculated location proximity. As an example, when a location of the standard photo is “Seoul”, a location of the comparison photo is “Busan”, and the predetermined value of the location difference is “100 m”, the location difference between the standard photo and the comparison photo is about 400 km, which is greater than the predetermined value of 100 m, arbitrarily set by the user. Accordingly, the system may determine the situation change as a location change, for example.

As another example, when a time change is detected, the system may calculate a time proximity between the standard photo and the comparison photo from the plurality of photos. The system may determine the situation change as a time change, when a time difference between the standard photo and the comparison photo is equal to, or greater than the predetermined value, according to the calculated time proximity. As an example, when time information for the standard photo is “May 10^{th} 2005”, time information of the comparison photo is “May 10^{th} 2006”, and the predetermined value is “30 days”, the time difference is “365 days”, which is greater than the predetermined value, “30 days”. Accordingly, the situation change detection unit 160 may determine the situation change as a time change.

In operation S615, the system may determine whether the situation change of the plurality of photos is detected according to one or more of a detected visual change, a face change, a location change, and a time change.

When the situation change is not detected, in operation S616, the system may analyze the plurality of photos, and may extract a “7W,” i.e. a When, Where, Who, with Which thing, What occasion, Which action, and Which category, according to an individual situation. Also, in operation S616, in order to prevent a repeated extraction with respect to a portion which is not changed compared to a previous photo when analyzing the plurality of photos, the system may deduce at least one of a date and time, a location, a person, an event, an object, a behavior and a pose, and a category of only a changed portion, after determining an unchanged portion.

As an example, in operation S616, when an individual situation is a date and time, the system may analyze the date and time information as photo information included in the plurality of photos, and may automatically deduce a user's annotation associated with a source time of the plurality of photos.

As another example, in operation S616, when the individual situation is a location, the system may analyze the location information, for example, GPS information, as the photo information included in the plurality of photos, and may automatically deduce the user's annotation associated with a source location of the plurality of photos.

As another example, in operation S616, when the individual situation is a person, the system may analyze the images of the plurality of photos, detects faces of previously registered persons, and may automatically deduce the user's annotation associated with the detected face.

As another example, in operation S616, when the individual situation is an object, the system may recognize objects of the plurality of photos, and may deduce the user's annotation associated with the recognized object automatically or limitedly.

As another example, in operation S616, when the individual situation is the event, or the behavior or pose, the system deduces what occasion or which action by using the user's annotation included in the plurality of photos.

As another example, in operation S616, when the individual situation is the category, the system may analyze the image of the plurality of photos, and may automatically deduce the category. When automatically deducing the category, and when a single category is selected, an error may occur. Accordingly, a soft annotation method may be used. For example, the individual situation inference unit 170 may provide, for example, a respective proportion such as a building 0.7%, a background scene 0.2%, and a water's edge 0.1%, and may deduce the category which has a greatest proportion. Also, the individual situation inference unit 170 may consider the user's annotation with the higher priority, when automatically deducing the category, for example.

In operation S617, the system may feedback the deduced individual situation to the user in order to confirm whether the deduced individual situation is suitable. Specifically, the system may confirm from the user whether the deduced individual situation and the photo are suitable after feeding back the deduced individual situation to the user. Accordingly, the system according to an embodiment of the present invention obtains the feedback from the user, and thereby may improve an accuracy in the deducing.

In operation S618, the system may determine whether the detected situation change is an overall situation change.

When the detected situation change is a partial situation change, the system may share the shared index in operation S619.

When the detected situation change is an overall situation change, the system may deduce a semantic relationship between situation segments according to the overall situation change in operation S620.

In operation S621, the system may index the plurality of photos according to the shared index or the situation change, and may store a semantic relationship between the shared index and the situation segments. Also, in operation S621, the system may generate and store a file name of the photos. Specifically, in operation S621, an indexing unit 180 of the system indexes an image of the plurality of photos based on one or more of the user's annotation, the semantic relationship, and the individual situation. Also, in operation S621, the system may store a relationship between the index and the plurality of photos in the index database 143, as a result of the indexing. Also, in operation S621, the system may generate a file name for each photo with respect to photos where the user's annotation is not inputted by the user.

The system may generate the file name as, for example, “when_where_who_event_serial number.JPG”, since photos are generally arranged in chronological order. In one or more embodiments, the system indexing photos semantically 100 may first provide source time information, then source location information, and lastly face information in the photo. Also, the system indexing photos semantically 100 may add additional context information, which is extracted from the photo, such as a description of the event that has occurred in the photo, and thereby may automatically generate the file name of the photo. The order described above, i.e. the source time information, and then the source location information, and lastly the face information in the photo, may be changed according to preference, as set by the user.

As an example, when the user primarily takes portrait photos, the face information of the portrait subject is most important. Accordingly, the face information may be first provided in the file name of the photo in operation S621, as an example.

As another example, when the user mainly considers the source location information most important, the source location information may first be provided in the file name of the photo in operation S621.

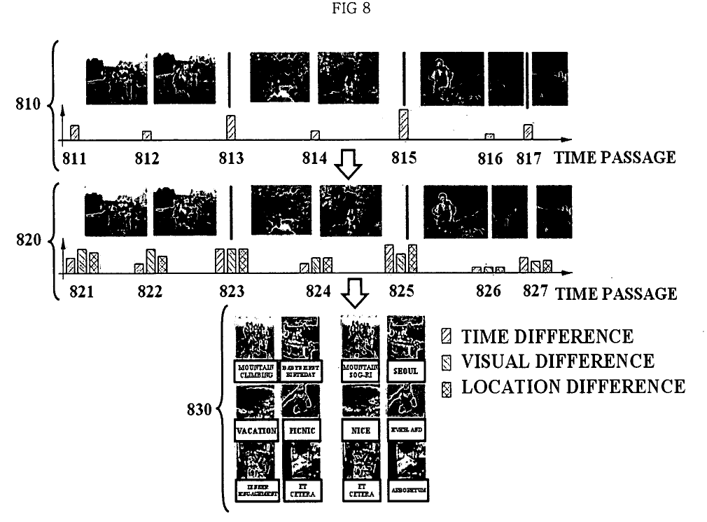

FIG. 8 illustrates an example of semantic indexing by a hierarchical grouping according to an embodiment of the present invention.

FIG. 8 illustrates a plurality of photos 810 that are grouped based on a time difference. The time difference 811, 812, 813, 814, 815, 816, and 817 of each photo is illustrated as time passing when the plurality of photos is taken. Here, the time difference of each photo refers to a difference in time when the each of the photos is taken. When the time difference of each photo is less than a predetermined time difference value, a location where the photos are taken, an event, and a face may be the same. Accordingly, the photos may be grouped as the same group. Also, when the time difference of each photo is equal to or greater than the predetermined time difference value, the location where the photos are taken, the event, and the face may not be the same. Accordingly, the photos may be grouped as a different group.

As an example, when the time difference 812 between a first photo and a second photo is less than the predetermined time difference value, the first photo and the second photo may be grouped into the same group.

As another example, when the time difference 813 between the second photo and a third photo is greater than the predetermined time difference value, the second photo and the third photo may be grouped into a different group, respectively, since the situation change occurs between the second photo and the third photo.

As another example, when the time difference 814 between the third photo and a fourth photo is less than the predetermined time difference value, the third photo and the fourth photo may be grouped into the same group.

As another example, when the time difference 815 between the fourth photo and a fifth photo is greater than the predetermined time difference value, the fourth photo and the fifth photo may be grouped as the different group, respectively, since the situation change occurs between the fourth photo and the fifth photo.

As another example, when the time difference 816 between the fifth photo and the sixth photo is less than the predetermined time difference value, the fifth photo and the sixth photo may be grouped as the same group

As another example, when the time difference 817 between the sixth photo and the seventh photo is greater than the predetermined time difference value, the sixth photo and the seventh photo may be grouped as the different group, respectively, since the situation change occurs between the sixth photo and the seventh photo.

FIG. 8 illustrates a plurality of photos 820, which are the same as the plurality of photos 810 above, and which are grouped based on the time difference, a visual difference, and a location difference, for example. The time difference, the visual difference, and the location difference 821, 822, 823, 824, 825, 826, and 827 of each photo are illustrated, as the time passes when the plurality of photos is taken. In this instance, the time difference refers to when each of the photos is taken. The visual difference refers to an image difference between comparison photos. The location difference refers to a difference in location where each of the photos is taken. When the time difference, the visual difference, and the location difference between the comparison photos are less than the predetermined value, a location where the comparison photos are taken, a situation, or a face may be the same. Accordingly, the comparison photos may be grouped as the same group. Also, when the time difference, the visual difference, and the location difference between the comparison photos are less than the predetermined value, the location where the photos are taken, the situation, and the face may not be identical. Accordingly, the comparison photos may be grouped as a different group.

As an example, when the time difference, the visual difference, and the location difference 822 between the first photo and the second photo are less than the predetermined value, the first photo and the second photo may be grouped as the same group.

As another example, when the time difference, the visual difference, and the location difference 823 between the second photo and the third photo is greater than the predetermined value, the second photo and the third photo may be grouped as the different group, respectively, since the situation change occurs between the second photo and the third photo.

As another example, when the time difference, the visual difference, and the location difference 824 between the third photo and the fourth photo is less than the predetermined value, the third photo and the fourth photo may be grouped as the same group.

As another example, when the time difference, the visual difference, and the location difference 825 between the fourth photo and the fifth photo is greater than the predetermined value, the fourth photo and the fifth photo may be grouped as the different group, respectively, since the situation change occurs between the fourth photo and the fifth photo.

As another example, when the time difference, the visual difference, and the location difference 826 between the fifth photo and the sixth photo is less than the predetermined value, the fifth photo and the sixth photo may be grouped as the same group.

As another example, when the time difference, the visual difference, and the location difference 827 between the sixth photo and the seventh photo is greater than the predetermined value, the sixth photo and the seventh photo may be grouped as the different group, respectively, since the situation change occurs between the sixth photo and the seventh photo.

FIG. 8 illustrates an example of a plurality of photos 830, which are the same as the plurality of photos 810 and 820, and which are classified according to a comparison and analysis. As an example, the plurality of photos is classified according to each situation. The situation may be classified into a category such as mountain climbing, a baby's first birthday, a vacation, a picnic, a dinner engagement, for example. As another example, the plurality of photos is classified according to each location. The location may be classified into Seoul, Nice, Everland, and an arboretum for example.

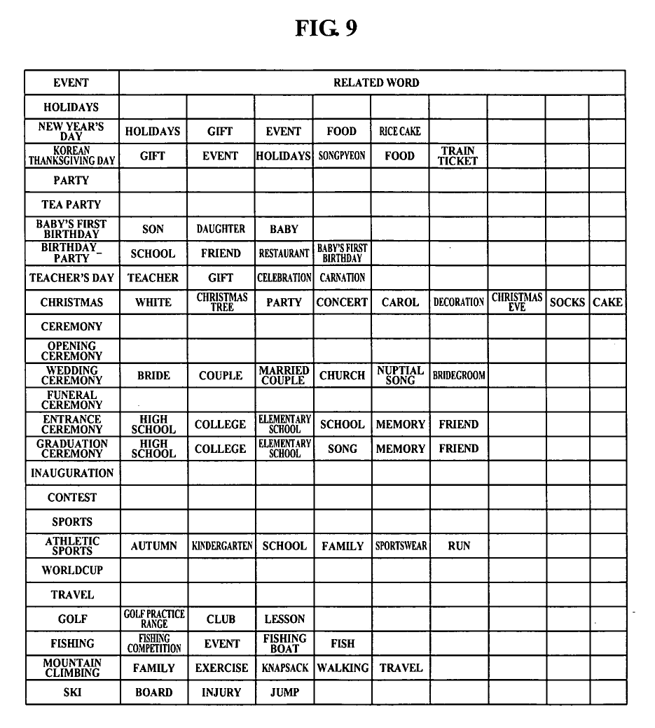

FIG. 9 illustrates an example of a related word which is associated with a social event, as criteria of a hierarchical grouping according to an embodiment of the present invention.

Referring to FIG. 9, as an example, when the social event is “New Year's day”, a related word associated with the “New Year's day” may be “event”, “holidays”, “gift”, “food”, and “rice cake”. Accordingly, when the categories such as “event”, “holidays”, “gift”, “food”, and “rice cake” are grouped as a low level index, a high level index corresponding to the low level index may be the “New Year's day”.

As another example, when the social event is a “wedding ceremony”, a related word associated with the “wedding ceremony” may be “bride”, “couple”, “married couple”, “church”, “nuptial song”, and “bridegroom”. Accordingly, when the high level index is the category “wedding ceremony”, the low level index corresponding to the high level index may be “bride”, “couple”, “married couple”, “church”, “nuptial song”, and “bridegroom,” as examples only.

In addition to this discussion, one or more embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDS), and storage/transmission media such as carrier waves, as well as through the Internet, for example. Here, the medium may further be a signal, such as a resultant signal or bitstream, according to one or more embodiments of the present invention. The media may also be a distributed network, so that the computer readable code is stored/transferred and executed in a distributed fashion. The media may also include, alone or in combination with the program instructions, data files, data structures, and the like. The media and program instructions may be those specially designed and constructed for the purposes of the present invention, or they may be of the kind well-known and available to those having skill in the computer software arts. Still further, as only an example, the processing element could include a processor or a computer processor, and processing elements may be distributed and/or included in a single device. The described hardware devices may be configured to act as one or more software modules in order to perform the operations of the above-described embodiments of the present invention.

A system, method, and medium indexing photos semantically according to the above-described embodiments of the present invention analyze a user's annotation and an image, and thereby may perform semantic indexing more accurately.

Also, a system, method, and medium indexing photos semantically according to the above-described embodiments of the present invention share a user's annotation as an index, analyze a plurality of photos, and perform semantic indexing according to a situation change.

Also, a system, method, and medium indexing photos semantically according to the above-described embodiments of the present invention perform semantic indexing only with a user's annotation in order to generate an index by using a deduced annotation and to deduce a relationship between a shared index and a segment.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of indexing a plurality of photos semantically based on a user's annotation, the method comprising:
analyzing the user's annotation and extracting a shared index from the user's annotation;
detecting a situation change in the plurality of photos; and
indexing the plurality of photos according to the situation change based on the shared index.

2. The method of claim 1, further comprising:
receiving the plurality of photos; and
receiving an annotation of at least one photo of the plurality of photos from the user.

3. The method of claim 2, wherein the photo comprises source location information and source time information.

4. The method of claim 1, wherein the detecting of the situation change detects any one or more of a visual change, a face change, a location change, and a time change of the plurality of photos, and further comprises determining the situation change of the plurality of photos according to the detected visual change, face change, location change, and time change.

5. The method of claim 4, wherein the detecting of the visual change comprises:
calculating a visual similarity of the plurality of photos; and
detecting the situation change as the visual change between a standard photo and a comparison photo, when a visual difference between the standard photo and the comparison photo is greater than a predetermined value, according to the calculated visual similarity.

6. The method of claim 4, wherein the detecting of the face change comprises:
comparing a face between a standard photo and a comparison photo from the plurality of photos; and
detecting the situation change as the face change between the standard photo and the comparison photo, when a face difference between the standard photo and the comparison photo is greater than a predetermined value, according to a result of the comparing.

7. The method of claim 4, wherein the detecting of the location change comprises:
calculating a location proximity between a standard photo and a comparison photo from the plurality of photos; and
detecting the situation change as the location change between the standard photo and the comparison photo, when a location difference between the standard photo and the comparison photo is greater than a predetermined value, according to the calculated location proximity.

8. The method of claim 4, wherein the detecting of the time change comprises:
calculating a time proximity between a standard photo and a comparison photo from the plurality of photos; and
detecting the situation change as the time change between the standard photo and the comparison photo, when a time difference between the standard photo and the comparison photo is greater than a predetermined value, according to the calculated time proximity.

9. The method of claim 1, further comprising:
deducing any one of a date and a time (when), a location (where), a person (who), an event (what occasion), an object (with which thing), a behavior and a pose (which action), and a category (which category), according to the situation change.

10. The method of claim 1, further comprising:
automatically generating a file name for one or more of the plurality of photos according to a result of the indexing.

11. At least one medium comprising computer readable code to control at least one processing element to implement a method of indexing a plurality of photos semantically based on a user's annotation, the method comprising:
analyzing the user's annotation and extracting a shared index from the user's annotation;
detecting a situation change in the plurality of photos; and
indexing the plurality of photos according to the situation change based on the shared index.

12. The medium of claim 11, further comprising:
receiving the plurality of photos; and
receiving an annotation of at least one photo of the plurality of photos from the user.

13. The medium of claim 11, wherein the detecting of the situation change detects any one or more of a visual change, a face change, a location change, and a time change of the plurality of photos, and further comprises determining the situation change of the plurality of photos according to the detected visual change, face change, location change, and time change.

14. The medium of claim 11, further comprising:
deducing any one of a date and a time (when), a location (where), a person (who), an event (what occasion), an object (with which thing), a behavior and a pose (which action), and a category (which category), according to the situation change.

15. The medium of claim 11, further comprising:
automatically generating a file name for one or more of the plurality of photos according to a result of the indexing.

16. A system for indexing a plurality of photos semantically based on a user's annotation, the system comprising:
a shared index extraction unit to analyze the user's annotation and extract a shared index from the user's annotation;
a situation change detection unit to detect a situation change; and
an indexing unit to index the plurality of photos according to the situation change based on the shared index.

17. The system of claim 16, further comprising a receiving unit comprising:
a photo receiving unit to receive the plurality of photos; and
a user's annotation input unit to receive an annotation of at least one photo of the plurality of photos from the user.

18. The system of claim 17, wherein the photo receiving unit comprises:
a photo sensor to photograph the plurality of photos;
a location measurement sensor to measure a source location where the plurality of photos are taken; and
a photo encoding unit to encode the photo.

19. The system of claim 18, wherein the photo encoding unit comprises:
an image encoder to encode an image of the photo; and
a photo information encoder to encode photo information including source location information and source time information of the photo.

20. The system of claim 17, wherein the shared index extraction unit comprises:
a user's annotation analyzer to analyze the user's annotation; and
a shared index extraction unit to extract the shared index according to a result of the analyzing.

21. The system of claim 17, wherein the situation change detection unit detects one or more of a visual change, a face change, a location change, and a time change of the plurality of photos, and determines the situation change of the plurality of photos according to the detected visual change, face change, location change, and time change.

22. The system of claim 21, wherein the situation change detection unit comprises:
a visual similarity calculation unit to calculate a visual similarity of the plurality of photos; and
a visual change determination unit to determine the situation change as the visual change, when a visual difference between a standard photo and a comparison photo greater than a predetermined value according to the calculated visual similarity.

23. The system of claim 21, wherein the situation change detection unit comprises:
a face comparison unit comparing a face between a standard photo and a comparison photo from the plurality of photos; and
a face change determination unit determining the situation change as the face change, when a face difference between the standard photo and the comparison photo is greater than a predetermined value according to a result of the comparing.

24. The system of claim 21, wherein the situation change detection unit comprises:
a location proximity calculation unit comparing location information of a standard photo and a comparison photo from the plurality of photos, and calculating a location proximity between the standard photo and the comparison photo; and
a location change determination unit determining the situation change as the location change, when a location difference between the standard photo and the comparison photo is greater than a predetermined value according to the calculated location proximity.

25. The system of claim 21, wherein the situation change detection unit comprises:
a time proximity calculation unit calculating a time proximity between a standard photo and a comparison photo from the plurality of photos; and
a time change determination unit determining the situation change as the time change, when a time difference between the standard photo and the comparison photo is greater than a predetermined value according to the calculated time proximity.

26. The system of claim 21, further comprising:
an individual situation inference unit analyzing the inputted photo and automatically deducing an image index including any one or more of a date and a time (when), a location (where), a person (who), an event (what occasion), an object (with which thing), a behavior and a pose (which action), and a category (which category).

27. The system of claim 17, further comprising:
an indexing unit to automatically generate a file name for at least one of the plurality of photos according to a result of the indexing.
